(19) United States
(12) Patent Application Publication
(10) Pub. No.: US 2003/0011567 A1
(43) Pub. Date: Jan. 16, 2003

(54) Method for pointing at information in multi-dimensional space

(75) Inventors: Jean-Yves Villet, Saint Romain En Jerez (FR); Sang-goog Lee, Anyang-city (KR); Kyung-ho Park, Suwon-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/090,643

(22) Filed: Mar. 6, 2002

(30) Foreign Application Priority Data
Jul. 12, 2001 (KR) 2001-42037

(51) Int. Cl. G09G 5/08

(52) U.S. Cl. 345/157

(57) ABSTRACT

A method for pointing at information in a multi-dimensional space is provided. The method includes the steps of (a) setting a portion of a full screen including a plurality of pieces of information, as a pointing screen; (b) determining whether desired information to be pointed at is included in the set pointing screen; (c) when it is determined that the desired information is not included in the pointing screen, moving the pointing screen so that the desired information can be included in the pointing screen; and (d) pointing at the desired information included in the pointing screen when it is determined that the desired information is included in the pointing screen or after step (c). At least one of steps (a), (c), and (d) is performed by a user's motion in at least one direction selected from up, down, forward, backward, to the left, and to the right.

### BACKGROUND OF THE INVENTION

1. Field of the Invention

The present invention relates to a pointing device such as a mouse, and more particularly, to a method for pointing at information in a multi-dimensional space using a wearable information input device. The present application is based on Korean Patent Application No. 2001-42037 filed on Jul. 12, 2001, which is incorporated herein by reference.

2. Description of the Related Art

Systems such as wearable computers have led to the necessity of a wearable information input device which performs the same functions as a mouse in a three-dimensional space. A wearable information input device should operate exactly and precisely according to the motion of a user's hand in a three-dimensional space just as when the user uses a mouse in a two-dimensional space. However, when a user moves an information input device to point at desired information in a three-dimensional space, noise may occur due to a shake of the hand. As a result, an information input device cannot be precisely operated in a three-dimensional space as compared to a mouse operated in a two-dimensional space.

Moreover, when a user points at information displayed at different positions on a large screen using an information input device in a three-dimensional space, it is very difficult and annoying to move the hand, on which a user wears a sensing unit included in an information input device, in order to move a pointer to the wanted position on the screen.

### SUMMARY OF THE INVENTION

To solve the above-described problems, it is an object of the present invention to provide a method for precisely and easily pointing at information in a multi-dimensional space, particularly in a three-dimensional space, using a wearable sensor.

To achieve the above object of the invention, there is provided a method for pointing at information in a multi-dimensional space. The method includes the steps of (a) setting a portion of a full screen including a plurality of pieces of information as a pointing screen; (b) determining whether desired information to be pointed at is included in the set pointing screen; (c) when it is determined that the desired information is not included in the pointing screen, moving the pointing screen so that the desired information can be included in the pointing screen; and (d) pointing at the desired information included in the pointing screen when it is determined that the desired information is included in the pointing screen or after step (c). It is preferable that at least one of steps (a), (c), and (d) is performed by a user's motion in at least one direction selected from up, down, forward, backward, to the left, and to the right.

### BRIEF DESCRIPTION OF THE DRAWINGS

The above object and advantages of the present invention will become more apparent by describing in detail preferred embodiments thereof with reference to the attached drawings in which:

FIG. 1 is a flowchart of a method for pointing at information in a multi-dimensional space according to the present invention;

FIG. 2 is a diagram of an example of a full screen for explaining a method for pointing at information in a multi-dimensional space according to the present invention;

FIG. 3 is a diagram of a preferred embodiment of a menu screen shown in FIG. 2;

FIG. 4 is a flowchart of a first embodiment of step 14 shown in FIG. 1 according to the present invention;

FIG. 5 is a flowchart of a second embodiment of step 14 shown in FIG. 1 according to the present invention;

FIG. 6 is a flowchart of a third embodiment of step 14 shown in FIG. 1 according to the present invention;

FIG. 7 is a flowchart of a fourth embodiment of step 14 shown in FIG. 1 according to the present invention;

FIG. 8 is a diagram of a full screen for exemplifying step 14 shown in FIG. 1;

FIG. 9 is a diagram of a finger for explaining a finger angle which is sensed by a sensing unit shown in FIG. 2;

FIG. 10 is a flowchart of an information input method using a finger angle;

FIG. 11 is a block diagram of an embodiment of an information input device for performing the information input method of FIG. 10;

FIG. 12 is a diagram of the appearance of a first embodiment of a first sensor shown in FIG. 11;

FIG. 13 is a diagram of an equivalent circuit of the first sensor shown in FIG. 12;

FIG. 14 is a diagram of the appearance of a second embodiment of the first sensor shown in FIG. 11;

FIGS. 15A through 15C are diagrams of the appearances of a third embodiment of the first sensor shown in FIG. 11;

FIG. 16 is a block diagram of a fourth embodiment of the first sensor shown in FIG. 11;

FIG. 17 is a diagram of the appearance of a fifth embodiment of the first sensor shown in FIG. 11;

FIG. 18 is a flowchart of a first embodiment of step 444 shown in FIG. 10;

FIG. 19 is a block diagram of a first embodiment of an information selection unit shown in FIG. 11 for performing step 444A shown in FIG. 18;

FIG. 20 is a flowchart of a second embodiment of step 444 shown in FIG. 10; and

FIG. 21 is a block diagram of a second embodiment of the information selection unit shown in FIG. 11 for performing step 444B shown in FIG. 20.

### DETAILED DESCRIPTION OF THE INVENTION

Hereinafter, a method for pointing at information in a multi-dimensional space according to the present invention will be described with reference to the attached drawings.

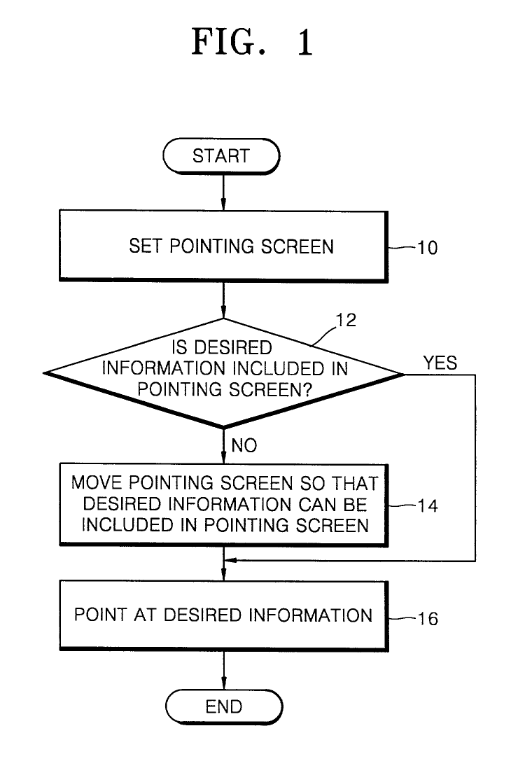

FIG. 1 is a flowchart of a method for pointing at information in a multi-dimensional space according to the present invention. The method includes setting a pointing screen in step 10, moving the pointing screen depending on whether desired information to be pointed at is included in the set pointing screen in steps 12 and 14, and pointing at the desired information in step 16.

The method of pointing at information shown in FIG. 1, according to the present invention, can be performed using an information input device having at least one sensor (not shown) which a user can wear on a predetermined portion of the body such as a hand and which can sense the direction of movement. The configuration and operation of such an information input device will be described later.

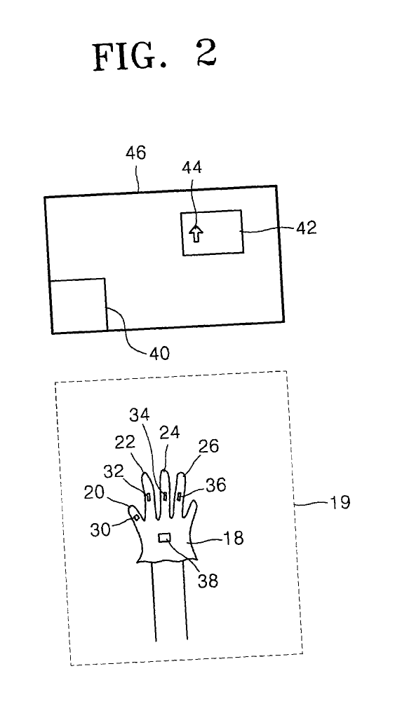

FIG. 2 is a diagram of an example of a full screen for explaining an information pointing method according to the present invention. A full screen 46 includes a menu screen 40 and a pointing screen 42.

According to an information pointing method according to the present invention, a portion of the full screen 46 of FIG. 2, which has pieces of information, is set as the pointing screen 42 in step 10. At least one of the horizontal and vertical sizes of the pointing screen 42 can be decided by a user. A plurality of pointing screens 42 may be displayed on the full screen 46. For example, the full screen 46 may have the menu screen 40 to allow a user to decide the size of the pointing screen 42 at his/her option. The following description concerns a procedure of deciding at least one of the horizontal and vertical sizes of the pointing screen 42 using the menu screen 40.

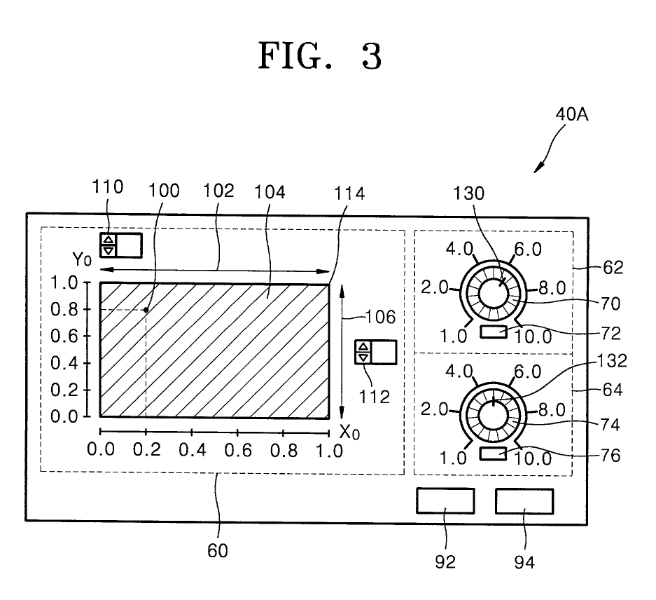

FIG. 3 is a diagram of a preferred embodiment 40A of the menu screen 40 shown in FIG. 2. The embodiment 40A includes a size menu 60, a speed menu 62, a reaction menu 64, and operating keys 92 and 94.

The size menu 60 of FIG. 3 is used for deciding at least one of the horizontal and vertical sizes 102 and 106 of the pointing screen 42. For example, a user puts a pointer 44 of FIG. 2 on a horizontal range display section 110 in the size menu 60 and clicks an upper arrow on the left portion of the horizontal range display section 110 one or more times by moving a sensor to increase the horizontal size 102 or clicks a lower arrow on the left portion of the horizontal range display section 110 one or more times by moving the sensor to decrease the horizontal size 102. Similarly, the user puts the pointer 44 on a vertical range display section 112 in the size menu 60 and clicks an upper arrow on the left portion of the vertical range display section 112 one or more times by moving the sensor to increase the vertical size 106 or clicks a lower arrow on the left portion of the vertical range display section 112 one or more times by moving the sensor to decrease the vertical size 106.

When a user wears the sensor on his/her hand, and the functions of a mouse is realized by moving the hand, as shown in FIG. 2, the pointer 44 is displayed on the pointing screen 42. The pointer 44 moves only within the pointing screen 42. Here, the full screen 46 may be a graphical-user interface screen.

After step 10, it is determined whether desired information which the user wants to point to is included in the set pointing screen 42 in step 12. If it is determined that the desired information is not included in the pointing screen 42, the pointing screen 42 is moved so that the desired information can be included in the pointing screen 42 in step 14.

Embodiments of step 14 of FIG. 1 according to the present invention will be described with reference to the attached drawings.

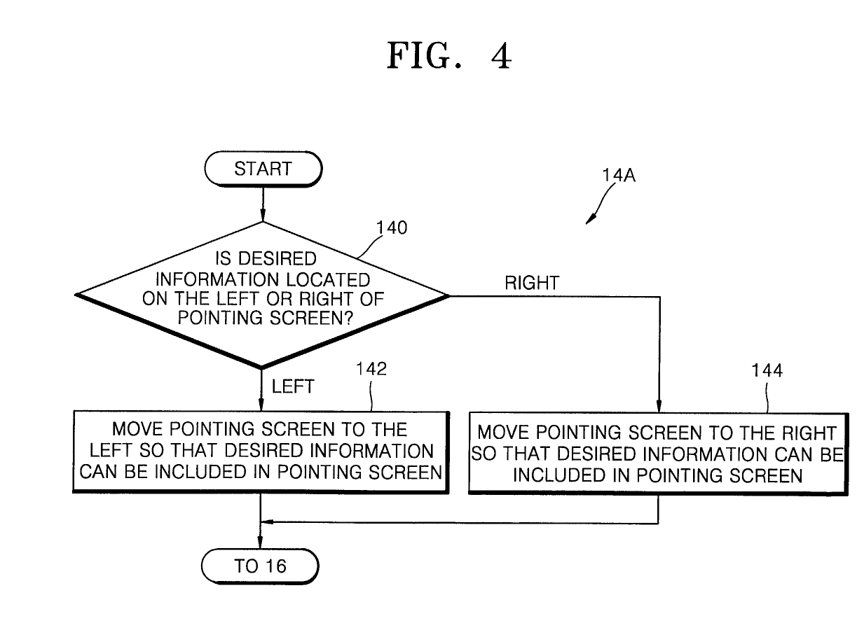

FIG. 4 is a flowchart of a first embodiment 14A of step 14 shown in FIG. 1 according to the present invention. The first embodiment 14A includes moving the pointing screen 42 to the left or right according to the position of the desired information to be pointed at in steps 140 through 144.

Referring to FIG. 4, if it is determined that the desired information is not included in the currently displayed pointing screen 42 in step 12, it is determined whether the desired information is located on the right or left of the pointing screen 42 in step 140. If it is determined that the desired information is located on the left of the pointing screen 42, the pointing screen 42 is moved to the left so that the desired information can be included in the pointing screen 42 in step 142, and the procedure goes to step 16. If it is determined that the desired information is located on the right of the pointing screen 42, the pointing screen 42 is moved to the right so that the desired information can be included in the pointing screen 42 in step 144, and the procedure goes to step 16.

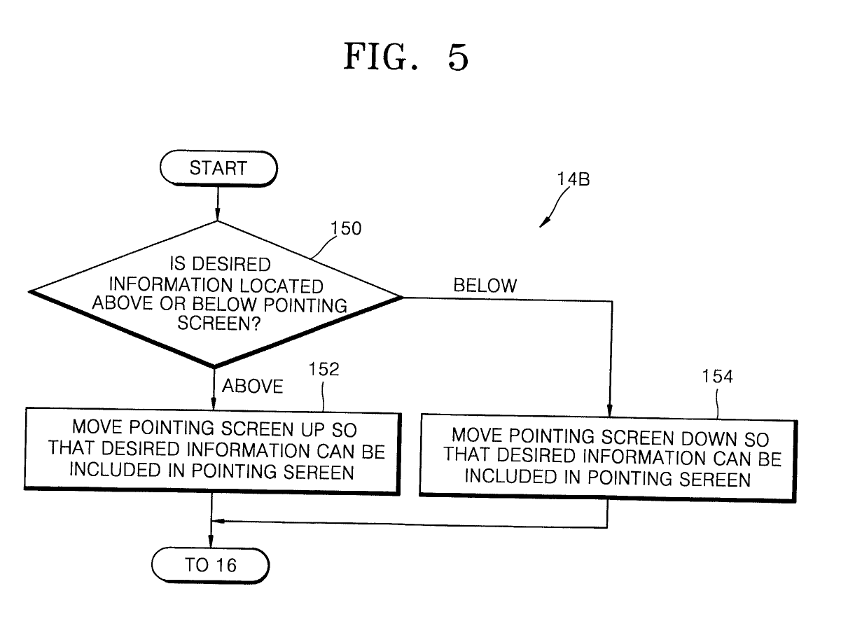

FIG. 5 is a flowchart of a second embodiment 14B of step 14 shown in FIG. 1 according to the present invention. The second embodiment 14B includes moving the pointing screen 42 up or down according to the position of the desired information to be pointed at in steps 150 through 154.

Referring to FIG. 5, if it is determined that the desired information is not included in the pointing screen 42 in step 12, it is determined whether the desired information is located above or below the pointing screen 42 in step 150. If it is determined that the desired information is located above the pointing screen 42, the pointing screen 42 is moved up so that the desired information can be included in the pointing screen 42 in step 152, and the procedure goes to step 16. If it is determined that the desired information is located below the pointing screen 42, the pointing screen 42 is moved down so that the desired information can be included in the pointing screen 42 in step 154, and the procedure goes to step 16.

FIG. 6 is a flowchart of a third embodiment 14C of step 14 shown in FIG. 1 according to the present invention. The third embodiment 14C includes moving the pointing screen 42 in at least one direction selected from up, down, to the left, and to the right according to the position of the desired information to be pointed at in steps 160 through 172.

Referring to FIG. 6, if it is determined that the desired information is not included in the pointing screen 42 in step 12, it is determined whether the desired information is located on the right or left of the pointing screen 42 in step 160. If it is determined that the desired information is located on the left of the pointing screen 42, the pointing screen 42 is moved to the left so that the pointing screen 42 can be located at the same horizontal position as the desired information in step 162. If it is determined that the desired information is located on the right of the pointing screen 42, the pointing screen 42 is moved to the right so that the pointing screen 42 can be located at the same horizontal position as the desired information in step 164.

It is determined whether the desired information is included in the pointing screen 42, which has been moved in step 162 or 164, in step 166. If it is determined that the desired information is included in the pointing screen 42, the procedure goes to step 16. However, if it is determined that the desired information is not included in the pointing screen 42, it is determined whether the desired information is located above or below the pointing screen 42 which has been moved in step 162 or 164, in step 168. If it is determined that the desired information is located above the pointing screen 42, the pointing screen 42 is moved up so that the desired information can be included in the pointing screen 42 in step 170, and the procedure goes to step 16. If it is determined that the desired information is located below the pointing screen 42, the pointing screen 42 is moved down so that the desired information can be included in the pointing screen 42 in step 172, and the procedure goes to step 16.

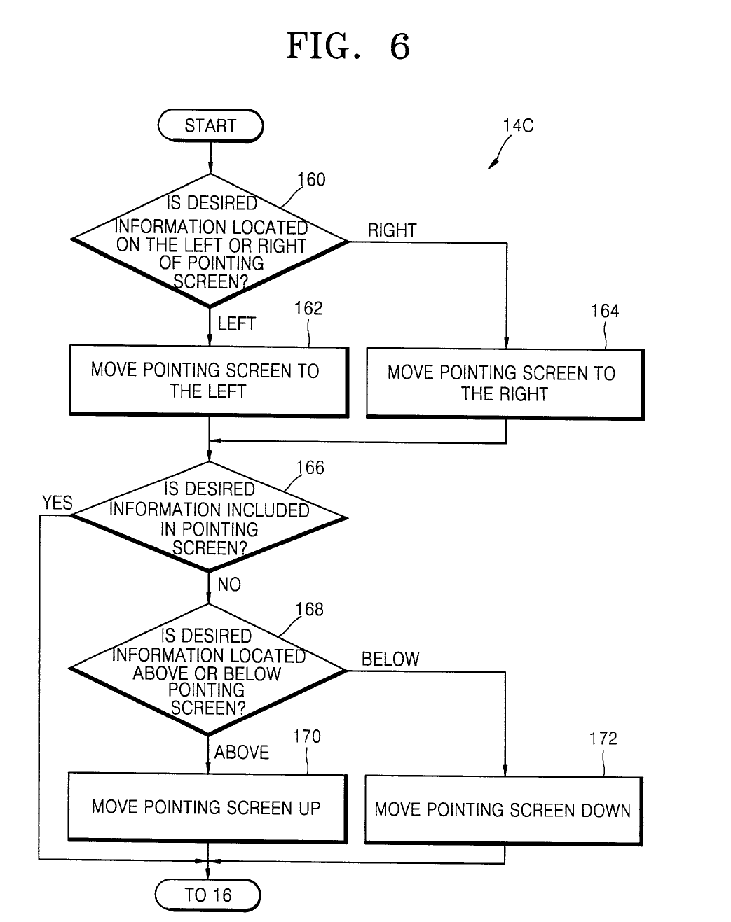

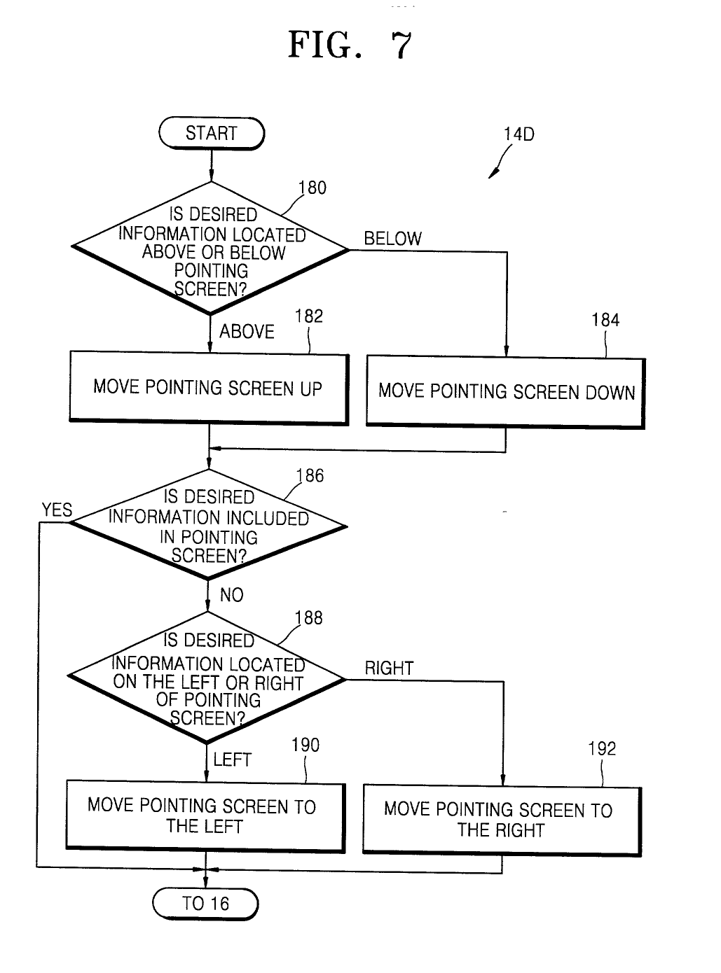

FIG. 7 is a flowchart of a fourth embodiment 14D of step 14 shown in FIG. 1 according to the present invention. The fourth embodiment 14D includes moving the pointing screen 42 in at least one direction selected from up, down, to the left, and to the right according to the position of the desired information to be pointed at in steps 180 through 192.

Referring to FIG. 7, if it is determined that the desired information is not included in the pointing screen 42 in step 12, it is determined whether the desired information is located above or below the pointing screen 42 in step 180. If it is determined that the desired information is located above the pointing screen 42, the pointing screen 42 is moved up so that the pointing screen 42 can be located at the same vertical position as the desired information in step 182. If it is determined that the desired information is located below the pointing screen 42, the pointing screen 42 is moved down so that the pointing screen 42 can be located at the same vertical position as the desired information in step 184.

It is determined whether the desired information is included in the pointing screen 42, which has been moved in step 182 or 184, in step 186. If it is determined that the desired information is included in the pointing screen 42, the procedure goes to step 16. However, if it is determined that the desired information is not included in the pointing screen 42, it is determined whether the desired information is located on the left or right of the pointing screen 42 which has been moved in step 182 or 184, in step 188. If it is determined that the desired information is located on the left of the pointing screen 42, the pointing screen 42 is moved to the left so that the desired information can be included in the pointing screen 42 in step 190, and the procedure goes to step 16. If it is determined that the desired information is located on the right of the pointing screen 42, the pointing screen 42 is moved to the right so that the desired information can be included in the pointing screen 42 in step 192, and the procedure goes to step 16.

A pointing screen may be moved to the left or right first and then moved up or down as described in the embodiment of FIG. 6. Alternatively, the pointing screen may be moved up or down first and then moved to the left or right as described in the embodiment of FIG. 7. However, the present invention is not restricted to these embodiments. The pointing screen may be moved in two dimensions at the same time. For example, the pointing screen may be moved to the left and up, to the right and up, to the left and down, or to the right and down.

According to the present invention, in step 14 of FIG. 1 and each of its embodiments shown in FIGS. 4 through 7, when it is determined that desired information is not included in a pointing screen, the pointing screen can be moved by moving a sensor beyond at least one of the horizontal and vertical motion ranges. Here, the horizontal motion range indicates a range in which the sensor can be moved to the left or right within the pointing screen, and the vertical motion range indicates a range in which the sensor can be moved up or down within the pointing screen.

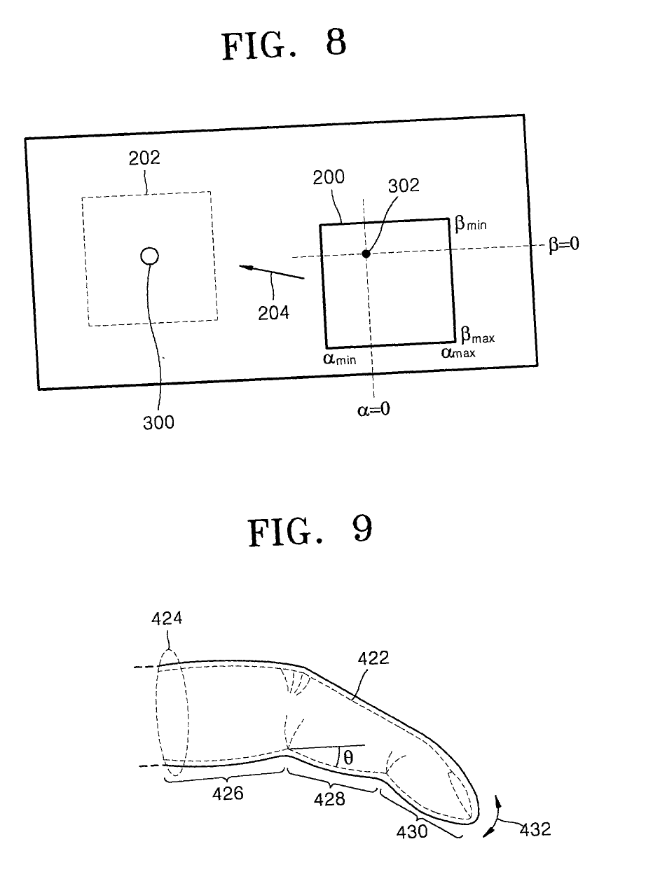

FIG. 8 is a diagram of a full screen for exemplifying step 14 shown in FIG. 1. Reference numeral 200 denotes a pointing screen before movement, and reference numeral 202 denotes a pointing screen after movement.

Referring to FIG. 8, it is assumed that maximum angles by which a sensor can be moved from an initial position 302 to the left (or counterclockwise) and to the right (or clockwise), respectively, within the pointing screen 200 are represented by αₘᵢₙ and αₘₐₓ, and maximum angles by which the sensor can be moved up and down, respectively, from the initial position 302 within the pointing screen 20 are represented by βₘᵢₙ and βₘₐₓ. An angle θ by which the sensor is moved to the left or right and an angle θ by which the sensor is moved up or down are 0° at the initial position 302. The horizontal motion range can be expressed by Equation (1), and the vertical motion range can be expressed by Equation (2).

αₘᵢₙ≦α≦αₘₐₓ (1)

βₘᵢₙ≦β≦βₘₐₓ (2)

Here, it is assumed that a has a negative (−) value when the sensor is moved to the left, α has a positive (+) value when the sensor is moved to the right, β has a negative value when the sensor is moved up, and β has a positive value when the sensor is moved down. According to an embodiment of the present invention, βₘᵢₙ and βₘₐₓ may be −25°, and 50°, respectively, and βₘᵢₙ and βₘₐₓ may be −20° and 45°, respectively.

Accordingly, when a user moves the sensor beyond αₘᵢₙ, the pointing screen 200 moves to the left. When the user moves the sensor beyond αₘₐₓ, the pointing screen 200 moves to the right. When the user moves the sensor beyond βₘᵢₙ, the pointing screen 200 moves up. When the user moves the sensor beyond βₘₐₓ, the pointing screen 200 moves down. For example, as shown in FIG. 8, if it is determined that the currently displayed pointing screen 200 does not include desired information 300 to be pointed at in step 12, the user can make the information 300 included in the pointing screen 202, which is moved in the direction of an arrow 204, that is, to the left, by moving the sensor beyond αₘᵢₙ.

Meanwhile, if it is determined that desired information is included in a currently displayed pointing screen in step 12, or after step 14, a user points to the desired information within the pointing screen in step 16.

At least one of the steps 10, 14, and 16 shown in FIG. 1 can be performed by moving a sensor (not shown) which a user wears on a predetermined portion of the body. In other words, each of the steps 10, 14, and 16 may be performed by moving the sensor, or step 10 may be performed by operating an information input device such as a key button other than an information input device having a wearable sensor.

When the size of the pointing screen 42 is set to be small in step 10, a range in which the pointer 44 can move is also small. Accordingly, the pointer 44 can be moved by moving a sensor just a little to the left, right, up, or down. However, the necessity of moving the pointing screen 42 having a small size increases because the pointing screen 42 includes a small amount of information compared to the full screen 46 of FIG. 1. In contrast, when the size of the pointing screen 42 is set to be large in step 10, the pointing screen 42 includes relatively greater amount of information than when the pointing screen 42 is set to be small. Accordingly, the necessity of moving the pointing, screen 42 decreases. However, the user must move the portion of his/her body to which the sensor is attached through a greater distance to move the pointer 44 when the size of the pointing screen 42 is set to be large. Therefore, the user can appropriately select the size of the pointing screen 42 shown in FIG. 2 taking into account the use of the pointing screen 42 and convenience in moving the sensor. For example, when it is necessary to frequently point at different types of information that are located close to each other, it is better to set the size of the pointing screen 42 small. Otherwise, it is better to set the size of the pointing screen 42 large.

In addition, according to the present invention, a user can freely set an initial position to be pointed at within the pointing screen 42 in step 10. For this, the user can use the size menu 60 of FIG. 3. For example, referring to FIG. 3, in determining an initial position, the user first locates the pointer 44 at desired coordinates (X₀, Y₀) 100 on a shaded plane 104 in the size menu 60 and then clicks the position of the coordinates (X₀, Y₀) 100 by moving the sensor, thereby setting the coordinate (X₀, Y₀) 100 as the initial position. For clarity, the coordinate axes X₀ and Y₀ of FIG. 3 apply a percentage.

According to where the initial position 100 of FIG. 3 is located within the pointing screen 42, it will be easy or difficult for a user to move the pointer 44 to the position of desired information. When the sensor is worn on the user's hand, if the user can more easily move the hand to the left than to the right, the user can make a motion range to the right smaller than a motion range to the left by setting the coordinate X₀ of the initial position 100 large in the size menu 60 of FIG. 3. In contrast, if the user can more easily move the hand to the right than to the left, the user can make a motion range to the left smaller than a motion range to the right by setting the coordinate X₀ of the initial position 100 small in the size menu 60 of FIG. 3. Alternatively, if the user can more easily move the hand up than down, the user can make a down motion range smaller than an up motion range by setting the coordinate Y₀ of the initial position 100 small in the size menu 60 of FIG. 3. In contrast, if the user can more easily move the hand down than moving the hand up, the user can make an up motion range smaller than a down motion range by setting the coordinate Y₀ of the initial position 100 large in the size menu 60 of FIG. 3. As described above, the user can freely select the initial position according to how much the user conveniently moves his/her body portion such as a hand on which he/she wears the sensor.

Moreover, according to the present invention, the user is allowed to set a moving speed of the pointing screen 42 in step 10. For this, the menu screen 40A shown in FIG. 3 may be provided with the speed menu 62 used for setting a moving speed of the pointing screen 42. The speed menu 62 includes a speed selection key 70 having a dial shape and a speed display window 72. If the user rotates the speed selection key 70 clockwise or counterclockwise by moving the sensor to locate an indicator 130 at a desired speed, the selected speed is displayed on the speed display window 72. For example, if the moving speed of the pointing screen 42 is set to a large value, the pointing screen 42 moves fast. In contrast, if the moving speed of the pointing screen 42 is set to a small value, the pointing screen 42 moves slowly.

Besides, according to the present invention, the user can set the degree of reaction of the pointer 44 to the motion of the sensor in step 10. For this, the menu screen 40A of FIG. 3 can be provided with the reaction menu 64 used for setting the degree of reaction of the pointer 44. The reaction menu 64 includes a reaction selection key 74 having a dial shape and a reaction display window 76. If the user rotates the reaction selection key 74 clockwise or counterclockwise by moving the sensor to locate an indicator 132 at a desired degree of reaction, the selected degree of reaction is displayed on the reaction display window 76. For example, when the degree of reaction is set to be high, the pointer 44 sensitively reacts to even a slight motion of the sensor and thus moves greatly. Accordingly, when it is necessary to frequently or greatly move the pointer 44, it is better to set the degree of reaction to be high. In contrast, when the degree of reaction is set to be low, the pointer 44 moves just a little even if the sensor moves a lot. Accordingly, when it is necessary to move the pointer 44 little by little or finely, it is better to set the degree of reaction to be low.

In addition, the user can point and click the operating key 92 by moving the sensor in order to prevent the menu screen 40A of FIG. 3 from being displayed on the full screen 46. The user can point at and click the operating key 94 by moving the sensor in order to apply the set values of the size of the pointing screen 42, initial position 100, degree of reaction, and/or moving speed to an information pointing method according to the present invention.

In the above-described information pointing method according to the present invention, in order to move the pointing screen 42 of FIG. 2 in at least one direction selected from up, down, to the left, and to the right, move the pointer 44 in at least one direction selected from up, down, to the left, and to the right within the pointing screen 42, or select a desired menu in the menu screen 40, by moving the sensor which a user wears on his/her predetermined body portion. There have been disclosed many conventional embodiments of an information input device for processing the sensing result generated from the moved sensor to recognize an operation of pointing at desired information or for processing the sensing result to determine information pointed at is input information.

Hereinafter, for clarity of the present invention, the configuration and operation of an embodiment of an information input device, which can be used for an information pointing method according to the present invention, and an information input method performed by the information input device will be described with reference to the attached drawings.

FIG. 9 is a diagram of a finger 422 for explaining a finger angle θ which is sensed by a sensing unit 19 shown in FIG. 2. Referring to FIGS. 2 and 9, a user can point to desired information, among a plurality pieces of information included in the pointing screen 42 on the full screen 46 of a monitor, by moving the finger 422 up or down as illustrated by an arrow 432. The information input device senses the bend of the finger 422 using the sensing unit 19, detects a finger angle θ, at which the finger 422 is bent, from the result of sensing, and recognizes information, which the user wishes to point to, based on the detected finger angle θ.

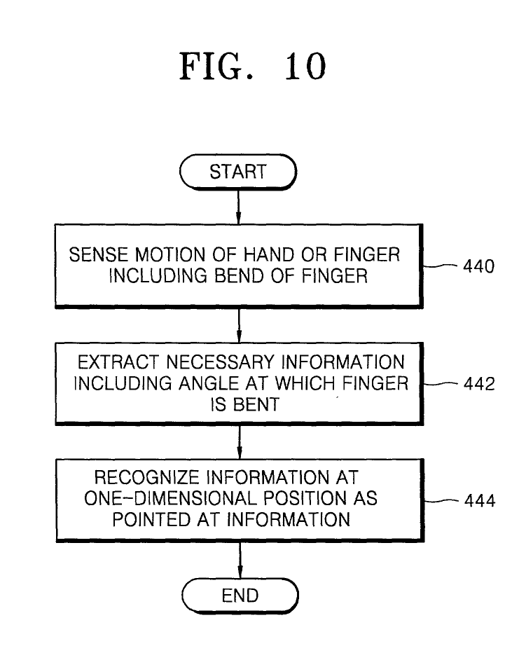

FIG. 10 is a flowchart of an information input method using a finger angle. The information input method includes obtaining necessary information from the motion of a finger or hand in steps 440 and 442, and selecting information located at a one-dimensional position derived from the obtained information in step 444.

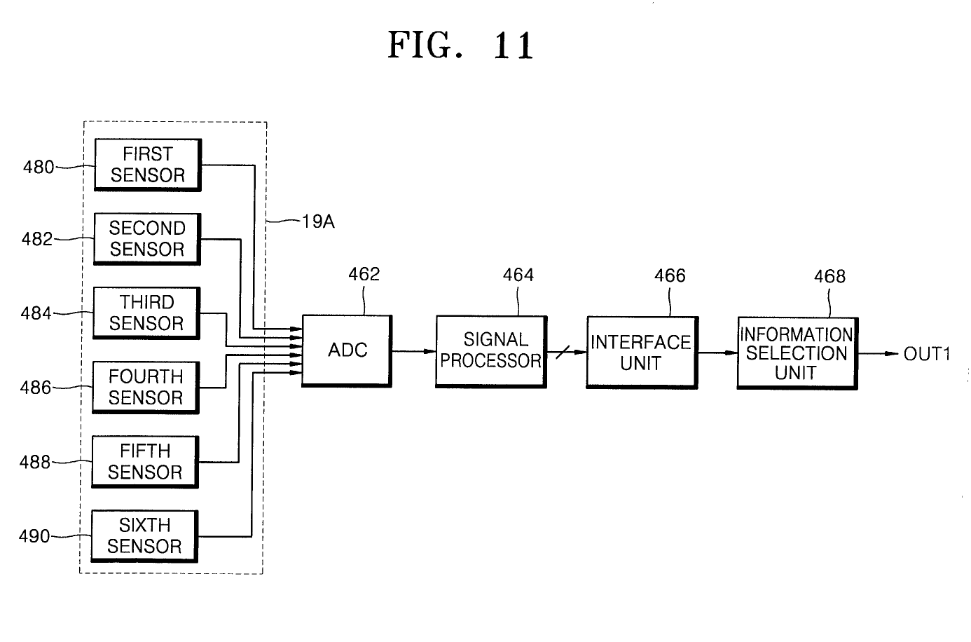

FIG. 11 is a block diagram of an embodiment of an information input device for performing the information input method of FIG. 10. The information input device includes a sensing unit 19A, an analog-to-digital converter (ADC) 462, a signal processor 464, an interface unit 466, and an information selection unit 468.

The sensing unit 19A of FIG. 11 is an embodiment of the sensing unit 19 of FIG. 2 and includes first through sixth sensors 480, 482, 484, 486, 488, and 490. Each of the first through sixth sensors 480, 482, 484, 486, 488, and 490 can be attached to a member having a glove shape which is worn on a hand and fingers, as shown in FIG. 2.

When a user moves at least one finger 422 to point at desired information among a plurality of pieces of information included in the pointing screen 42, the first sensor 480 senses the bend of the finger 422 and outputs the result of sensing in step 440. When pointing at the information, the user may or may not see the pointing screen 42. The result of sensing output from the first sensor 480 may have an analog or digital form according to the type of implementation of the first sensor 480. When the result of sensing output from the first sensor 480 has an analog form, the ADC 462 is additionally provided between the sensing unit 19A and the signal processor 464, as shown in FIG. 11. The ADC 462 converts at least one result of sensing output from the sensing unit 19A into a digital form and outputs the result of conversion to the signal processor 464. For example, the ADC 462 can perform Pulse Width Modulation (PWM) on a voltage output from the sensing unit 19A in an analog form and output the result of PWM to the signal processor 464.

Hereinafter, the configurations and operations of embodiments of the first sensor 480 will be described with reference to the attached drawings.

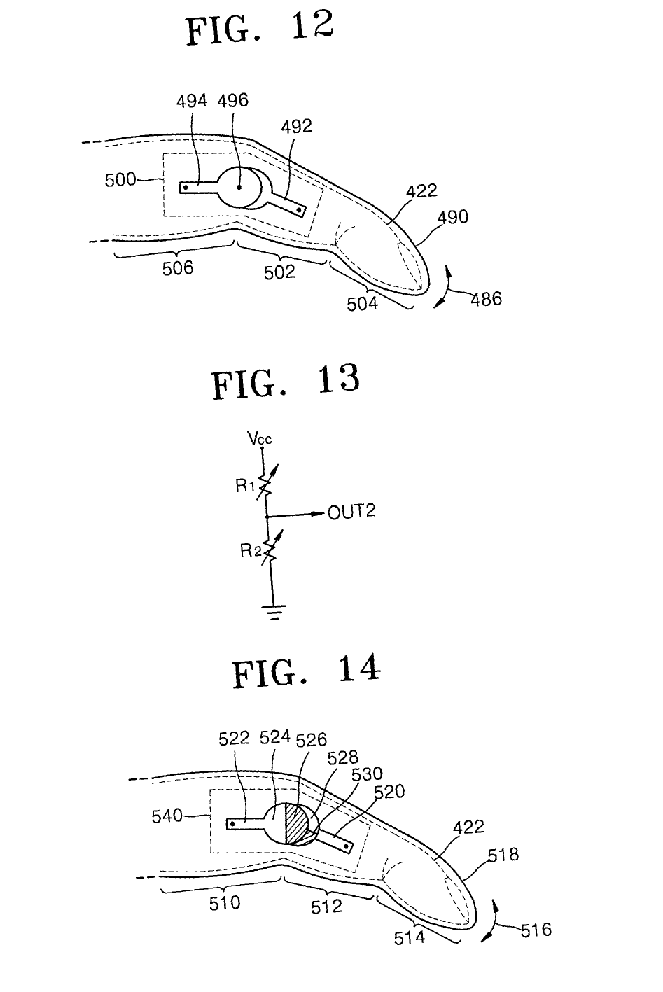

FIG. 12 is a diagram of the appearance of a first embodiment of the first sensor 480 shown in FIG. 11. FIG. 12 shows a glove 490 worn on the finger 422 and a first sensor 500 attached to the glove 490.

Referring to FIG. 12, the first sensor 500 may be realized as a variable resistor which is disposed to extend from one segment to another segment of the finger 422, varies resistance according to a finger angle θ formed when a user moves the finger 422 up or down, and outputs the result of sensing having a level corresponding to the varied resistance. The segments of the finger 422 used for sensing may be a third segment 506 and a second segment 502, as shown in FIG. 12, or may be the third segment 506 and a first segment 504, unlike FIG. 12.

For this, the first sensor 500 may include a first fixed member 494, a first moving member 492, and a central axis 496. The first fixed member 494 is attached to one segment of the finger 422, and the first moving member 492 is attached to another segment of the finger 422. The first fixed member 494 and the first moving member 492 are connected to each other by the central axis 496 to thus operate together. When the finger 422 is moved up or down as illustrated by an arrow 486, the first fixed member 494 does not move, but the first moving member 496 moves. Accordingly, the first sensor 500 varies resistance according to the motion of the first moving member 492 as follows.

FIG. 13 is a diagram of an equivalent circuit of the first sensor 500 shown in FIG. 12. The equivalent circuit includes resistors R1 and R2. Referring to FIG. 13, when the finger 422 is spread out without being bent, the resistors R1 and R2 have the same value. As the finger 422 is bent downward, the resistors R1 and R2 have different values. Accordingly, as the finger 422 is bent, a voltage value output through an output terminal OUT2 changes. Consequently, the first sensor 500 of FIG. 12 outputs a voltage having a level varying with a bend of the finger 422 as the result of sensing.

FIG. 14 is a diagram of the appearance of a second embodiment of the first sensor 480 shown in FIG. 11. FIG. 14 shows a glove 518 worn on the finger 422 and a first sensor 540 attached to the glove 518.

Referring to FIG. 14, the first sensor 540 may be realized as a variable capacitor, that is, a trimmer capacitor, which is disposed to extend from one segment to another segment of the finger 422, varies capacitance according to a finger angle θ at which the finger 422 is bent, and outputs the result of sensing having a level corresponding to the varied capacitance. The segments of the finger 422 may be a third segment 510 and a second segment 512, as shown in FIG. 14, or may be the third segment 510 and a first segment 514, unlike FIG. 14.

For this, the first sensor 540 may include a second fixed member 522 and a second moving member 520. The second fixed member 522 is attached to one segment of the finger 422 and has a nonconductor 524 and a conductor 526. The second moving member 520 is attached to another segment of the finger 422 and has a nonconductor 528 and a conductor 530. As the finger 422 is bent, that is, as the finger is moved up or down as illustrated by an arrow 516, the second fixed member 522 does not move, but the second moving member 520 moves. Accordingly, an area in which the conductor 526 of the second fixed member 522 overlaps the conductor 530 of the second moving member 520 changes as the finger 422 is bent. A change in the area of an overlap causes capacitance to change. Here, the first sensor 540 outputs a voltage, which has a level varying with a variation of capacitance, in an analog form as the result of sensing.

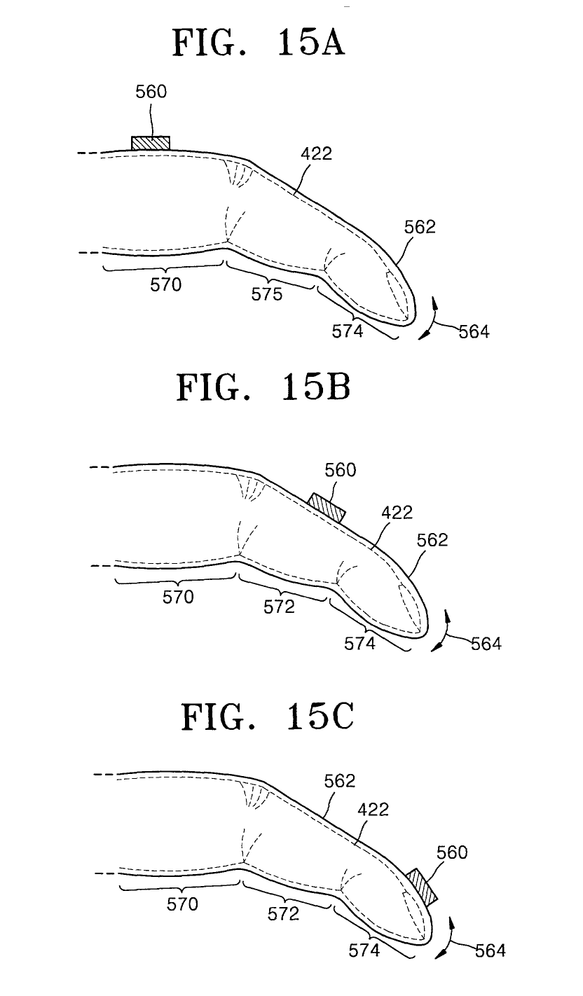

FIGS. 15A through 15C are diagrams of the appearances of a third embodiment of the first sensor 480 shown in FIG. 11. FIGS. 15A through 15C show a glove 562 worn on the finger 422 and a first sensor 560 attached to the glove 562.

Referring to FIGS. 15A through 15C, the first sensor 560 may be disposed in any segment of the finger 422 and may be realized as an inertial sensor which senses an angle at which the finger 422 is bent and outputs the result of sensing. Here, the inertial sensor 560 may be attached to a third segment 570 as shown in FIG. 15A, to a second segment 572 as shown in FIG. 15B, or to a first segment 574 as shown in FIG. 15C. For this, the inertial sensor 560 can be realized as a gyro sensor (not shown) or an acceleration sensor (not shown). When the inertial sensor 560 is realized as a gyro sensor, the inertial sensor 560 detects an angular velocity which varies as the finger 422 is moved up or down as illustrated by an arrow 564 and outputs a voltage, which has a level corresponding to the detected angular velocity, in an analog form as the result of sensing. However, when the inertial sensor 560 is realized as an acceleration sensor, the inertial sensor 560 detects acceleration which varies as the finger 422 is moved up or down as illustrated by the arrow 564 and outputs a voltage, which has a level corresponding to the detected acceleration, in an analog or digital form as the result of sensing.

FIG. 16 is a block diagram of a fourth embodiment of the first sensor 480 shown in FIG. 11. The fourth embodiment of the first sensor 480 includes a light emitter 590, a rotary circular plate 592, and a light receiving unit 594.

Referring to FIG. 16, the rotary circular plate 592 rotates around a central axis 600 clockwise or counterclockwise, as illustrated by the arrow 598, when the finger 422 is bent and has a plurality of holes 596 at its outer portion. The light emitter 590 radiates light at the holes 596 on the rotary circular plate 592. The light receiver 594 receives light transmitted through the holes 596 or reflected from the holes 596, converts the received light into an electrical signal, and outputs the electrical signal through an output terminal OUT3 as the result of sensing. For example, once the finger 422 is bent to point to desired information, the rotary circular plate 592 rotates clockwise or counterclockwise, as illustrated by an arrow 598, and the light receiver 594 outputs an electrical signal in a digital form through the output terminal OUT3. The electrical signal consists of pulses generated per hour according to the rotation of the rotary circular plate 592. Accordingly, the ADC 462 of FIG. 11 is not necessary in this embodiment. The configuration and operation of the first sensor of FIG. 16 are the same as those of a rotary encoder.

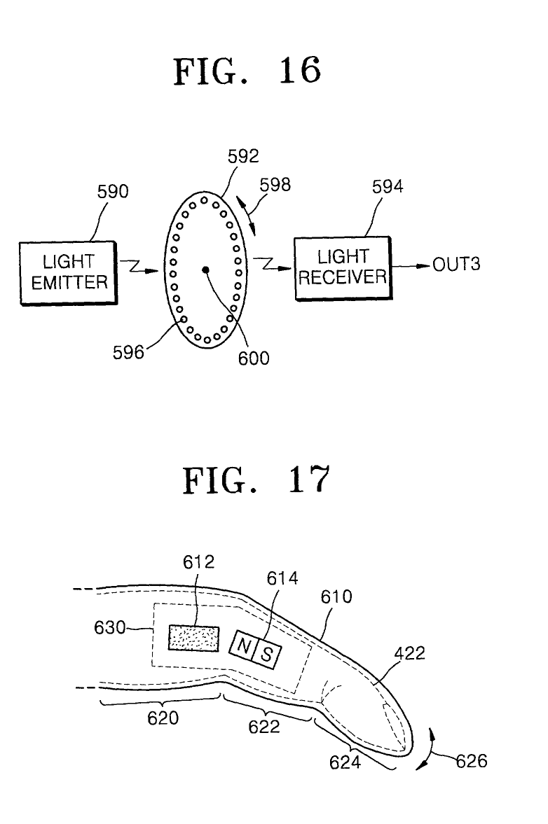

FIG. 17 is a diagram of the appearance of a fifth embodiment of the first sensor 480 shown in FIG. 11. FIG. 17 shows a glove 610 worn on the finger 422 and a first sensor 630 attached to the glove 610.

Referring to FIG. 17, the first sensor 630 includes a magnet 614 and a flux direction measurer 612. The magnet 614 is disposed in one segment of the finger 422, and the flux direction measurer 612 is disposed in another segment of the finger 422 in the direction of magnetic flux induced by the magnet 614. The flux direction measurer 612 measures the direction of magnetic flux and outputs the measured direction as the result of sensing. It is preferable that the segment to which the magnet 614 is attached is close to the end of the finger 422 (outer segment), and the segment to which the flux direction measurer 612 is attached is close to the base of the finger 422 (inner segment). Since the output of the flux direction measurer 612 may be wirely connected to the ADC 462, it is preferable to dispose the flux direction measurer 612 in an inner segment which moves less and to dispose the magnet 614 in an outer segment which moves more. Here, as shown in FIG. 17, the outer segment is a second segment 622 counted from the end of the finger 422, and the inner segment is a third segment 620 counted from the end of the finger 422. Unlike in FIG. 17, the outer segment can be a first segment 624 counted from the end of the finger 422, and the inner segment can be the third segment 620 counted from the end of the finger 422. The flux direction measurer 612 detects the direction of magnetic flux varying as the finger 422 moves up or down as illustrated by an arrow 626 and outputs the detected direction as the result of sensing in an analog form. For this, the flux direction measurer 612 can be realized as a giant magneto resistive (GMR) sensor (not shown).

The first sensor 480 or any one of its embodiments can be attached to any segment of at least one among the fingers of the right hand and/or the left hand. However, as described above, it is preferable to dispose the first sensor 480 and its embodiments at a portion of the finger 422 where the change of angles through which the finger 422 is bent is a maximum when a user bends the finger 422 to point at information.

In addition to a bend of the finger 422, the sensing unit 19A of FIG. 11 can sense other motions of the hand or finger 422 as follows in step 440. For this, the second sensor 482 senses an up or down motion of the finger 422 and outputs the result of sensing. The third sensor 484 senses an up or down motion of the hand and outputs the result of sensing. The fourth sensor 486 senses a leftward or rightward motion of the hand and outputs the result of sensing. The fifth sensor 488 senses a leftward or rightward motion of the finger 422 and outputs the result of sensing. The sixth sensor 490 senses a motion of a third knuckle 424 counted from the end of the finger 422 and outputs the result of sensing. The sixth sensor 490 may be disposed in the first, second, or third segment 430, 428, or 426 of the finger 422. Here, the second sensor 482, the fifth sensor 488, and/or the sixth sensor 490 can be disposed at any segment of at least one finger 422 of the right hand and/or the left hand. The third sensor 484 and/or the fourth sensor 486 can be disposed on the palm and/or the back of the right hand and/or the left hand. However, it is preferable that each of the second, third, fourth, fifth, and sixth sensors 482, 484, 486, 488, and 490 is disposed at a segment where the range of a motion of the hand or finger is a maximum.

Each of the second, third, fourth, fifth, and sixth sensors 482, 484, 486, 488, and 490 shown in FIG. 11 can be realized as an inertial sensor. For example, an inertial sensor (not shown) implemented as the second, fifth, or sixth sensor 482, 488, or 490, is attached to the finger 422, senses the upward, downward, leftward, or rightward motion of the finger 422 or the motion of the third knuckle 424, and outputs the result of sensing. An inertial sensor (not shown) implemented as the third or fourth sensor 484 or 486, is attached to the hand, senses the upward, downward, leftward, or rightward motion of the hand, and outputs the result of sensing. The inertial sensor implemented as each of the second, third, fourth, fifth, and sixth sensors 482, 484, 486, 488, and 490, can be realized as a gyro sensor (not shown) or an acceleration sensor (not shown). When the inertial sensor is realized as a gyro sensor, the inertial sensor outputs a voltage, which has a level corresponding to angular velocity which varies according to the motion of the hand or finger, in an analog form as the result of sensing. However, when the inertial sensor is realized as an acceleration sensor, the inertial sensor outputs a voltage, which has a level corresponding to acceleration which varies according to the motion of the hand or finger, in an analog or digital form, as the result of sensing.

The results of sensing output from the second, third, fourth, and fifth sensors 482, 484, 486, and 488 are used for recognizing information pointed to by a user in the pointing screen 42. The result of sensing output from the sixth sensor 490 is used for determining whether the user clicks the pointed information to determine it as input information.

After step 440, the signal processor 464 calculates an angle θ, at which the finger 422 is bent, from the result of sensing received from the first sensor 480 in step 442. If the first sensor 480 is realized as shown in FIGS. 12, 14, 15A, 15B, or 15C, the signal processor 464 calculates an angle θ, at which the finger 422 is bent, from a voltage having a level corresponding to varied resistance, varied capacitance, varied angular velocity or acceleration in a digital form. However, if the first sensor 480 is realized as shown in FIG. 16, the signal processor 464 counts the number of pulses of an electrical signal received from the light receiver 594 per unit time and calculates an angle θ, at which the finger 422 is bent, from the result of counting. If the first sensor 480 is implemented as shown in FIG. 17, the signal processor 464 calculates an angle θ from a direction measured by the flux direction measurer 612.

In addition to the calculation of an angle θ, as described above, after step 440, the signal processor 464 can calculate necessary information, i.e., various types of displacement, from the result of sensing the motion of the hand and/or finger 422 in step 442. For this, the signal processor 464 calculates the degree of the upward or downward motion of the finger 422 as a first displacement from the result of sensing output from the second sensor 482, calculates the degree of the upward or downward motion of the hand as a second displacement from the result of sensing output from the third sensor 484, calculates the degree of the leftward or rightward motion of the hand as a third displacement from the result of sensing output from the fourth sensor 486, calculates the degree of the leftward or rightward motion of the finger 422 as a fourth displacement from the result of sensing output from the fifth sensor 488, and calculates the degree of the motion of the third knuckle 424 from the end of the finger 422 as a fifth displacement from the result of sensing output from the sixth sensor 490.

Here, when the ADC 462 is provided, the signal processor 464 calculates an angle and/or relevant displacement, from the result of sensing received from the ADC 462 in a digital form. However, when the ADC 462 is not provided, the signal processor 464 calculates an angle and/or relevant displacement from the result of sensing received from the sensing unit 19A. The interface unit 466, which is selectively provided between the signal processor 464 and the information selection unit 468 in FIG. 11, converts the angle and/or various types of displacement received from the signal processor 464 into a transmission form and transmits, with or without wires, the converted angle and/or displacement to the information selection unit 468.

Meanwhile, when the sensing unit 19A is realized as the first sensor 480 only, after step 442, the information selection unit 468 determines a one-dimensional position in the pointing screen 42 from the angle calculated by the signal processor 464, recognizes information at the one-dimensional position as information which a user wishes to point to, and outputs the information at the one-dimensional position through an output terminal OUT1 in step 444. The one-dimensional position may be a horizontal position or a vertical position within the pointing screen 42.

When the sensing unit 19A includes the second sensor 482 and/or the third sensor 484 in addition to the first sensor 480, after step 442, the information selection unit 468 determines a one-dimensional position in the pointing screen 42 from the first displacement and/or second displacement and the angle, recognizes information at the one-dimensional position as information which a user wishes to point to, and outputs the information at the one-dimensional position through the output terminal OUT1 in step 444.

Hereinafter, a first embodiment 444A of step 444 and the configuration and operation of the information selection unit 468 performing step 444A will be described with reference to the attached drawings.

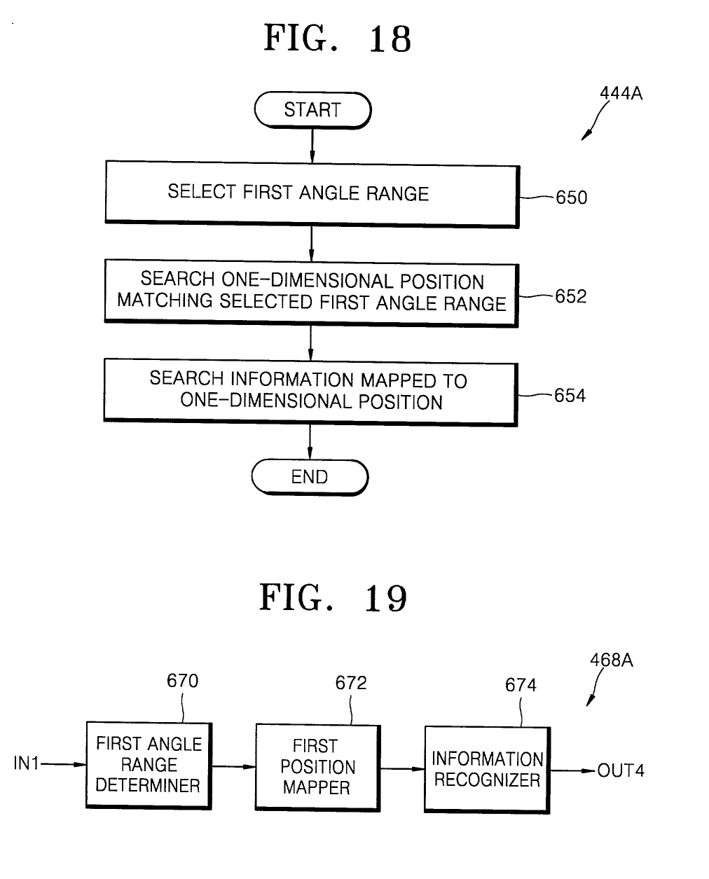

FIG. 18 is a flowchart of the first embodiment 444A of step 444 shown in FIG. 10. The step 444A includes finding information at a one-dimensional position found based on a relevant first angle range in sub-steps 650 through 654.

FIG. 19 is a block diagram of a first embodiment 468A of the information selection unit 468 shown in FIG. 11 for performing step 444A shown in FIG. 18. The first embodiment 468A of the information selection unit 468 includes a first angle range determiner 670, a first position mapper 672, and an information recognizer 674.

After step 442, a relevant first angle range is selected from a first predetermined number of predetermined first angle ranges in step 650. The first predetermined number indicates the number of one-dimensional positions and denotes the number of pieces of information in a horizontal or vertical direction within the pointing screen 42.

When the signal processor 464 calculates only the angle, in order to perform step 650, the first angle range determiner 670 compares the angle input from the signal processor 464 through an input terminal IN1 with a first predetermined number of the predetermined first angle ranges, selects a first angle range including the angle calculated by the signal processor 464 in response to the result of the comparison, and outputs the selected first angle range to the first position mapper 672. For example, when it is assumed that the angle can be calculated in a range of 0-90°, the first predetermined number is 3, and the predetermined first angle ranges are 0-30°, 30-60°, and 60-90°, the first angle range determiner 670 determines in which range the angle calculated by the signal processor 464 is included among the three first angle ranges in step 650.

When the signal processor 464 calculates the angle and the first displacement and/or the second displacement, in order to perform step 650, the first angle range determiner 670 receives the angle and the first displacement and/or the second displacement from the signal processor 464 through the input terminal IN1 and selects a first angle range including the sum of the input angle and an angle corresponding to the first displacement and/or the second displacement.

After step 650, a one-dimensional position mapped from the selected first angle range is searched in step 652. For this, the first position mapper 672 searches a one-dimensional position mapped in the first angle range input from the first angle range determiner 670 and outputs the searched one-dimensional position to the information recognizer 674.

After step 652, in step 654, information mapped to the searched one-dimensional position is searched, and the searched information is recognized as information pointed to by the user. For this, the information recognizer 674 searches information mapped to the one-dimensional position input from the first position mapper 672, recognizes the searched information as information pointed to by the user, and outputs the recognized information through an output terminal OUT4. For this, the information recognizer 674 may include a storage unit (not shown) for previously storing information corresponding to one-dimensional positions or the coordinate values of the information, and a reader (not shown) for reading information or a coordinate value from the storage unit by using the one-dimensional position input from the first position mapper 672, as an address.

However, when the sensing unit 19A includes the fourth sensor 486 and/or the fifth sensor 488 in addition to the first sensor 480, after step 442, the information selection unit 468 determines a two-dimensional position in the pointing screen 42 from the third displacement and/or the fourth displacement and the angle, and recognizes information at the determined two-dimensional position as information pointed to by the user in step 444. Here, the two-dimensional position denotes a position in horizontal and vertical directions within the pointing screen 42.

Hereinafter, a second embodiment 444B of step 444 and the configuration and operation of the information selection unit 468 performing step 444B will be described with reference to the attached drawings.

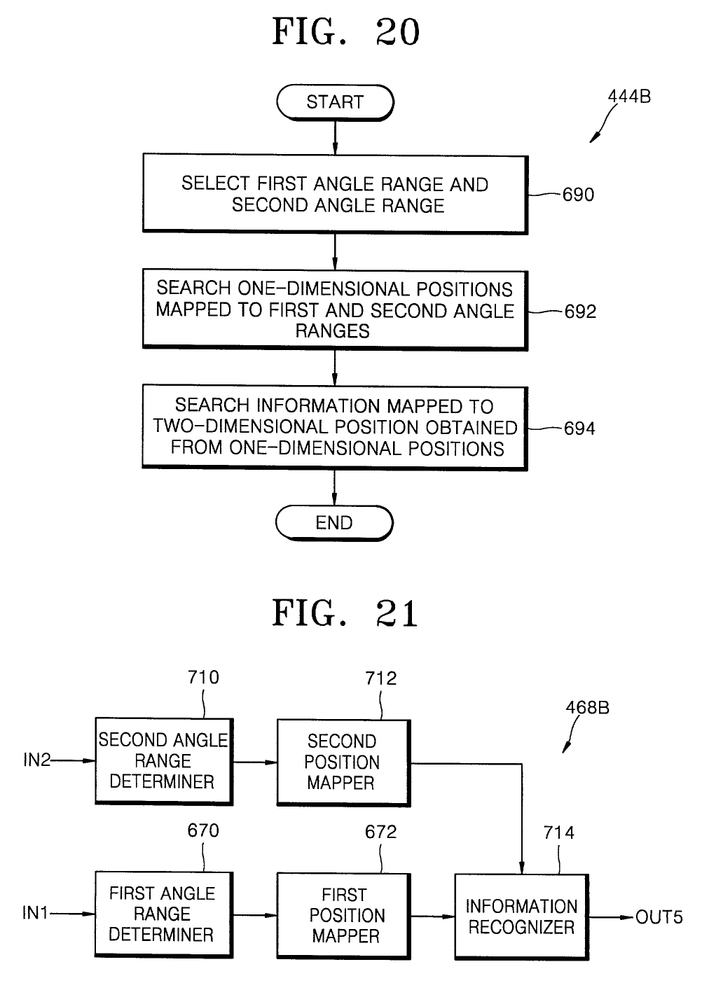

FIG. 20 is a flowchart of the second embodiment 444B of step 444 shown in FIG. 10. The second embodiment 444B of step 444 includes searching one-dimensional positions based on a relevant first angle range and a relevant second angle range in steps 690 and 692, and searching information using a two-dimensional position searched based on the one-dimensional positions in step 694.

FIG. 21 is a block diagram of a second embodiment 468B of the information selection unit 468 shown in FIG. 11 for performing step 444B shown in FIG. 20. The second embodiment 468B of the information selection unit 468 includes first and second angle range determiners 670 and 710, first and second position mappers 672 and 712, and an information recognizer 714.

After step 442, in step 690, a relevant first angle range is selected from a first predetermined number of first angle ranges, and a relevant second angle range is selected from a second predetermined number of predetermined second angle ranges. The second predetermined number indicates the number of one-dimensional positions to which the second angle ranges can be mapped. If the first predetermined number indicates the number of pieces of information in a horizontal direction within the pointing screen 42, the second predetermined number indicates the number of pieces of information in a vertical direction within the pointing screen 42. In contrast, if the first predetermined number indicates the number of pieces of information in the vertical direction within the pointing screen 42, the second predetermined number indicates the number of pieces of information in the horizontal direction within the pointing screen 42.

In step 690, the selecting of the relevant first angle range is the same as in step 650, so a description thereof will be omitted. In other words, the first angle range is selected by the first angle range determiner 670 of FIG. 21 which is the same as that of FIG. 19. In order to select the relevant second angle range, the second angle range determiner 710 compares the second predetermined number of predetermined second angle ranges with the third displacement and/or the fourth displacement input from the signal processor 464 through an input terminal IN2, selects a second angle range including the third displacement and/or the fourth displacement in response to the result of comparison, and outputs the selected second angle range to the second position mapper 712. In other words, when the signal processor 464 calculates a third displacement and/or a fourth displacement, the second angle range determiner 710 selects a relevant second angle range including the third displacement and/or the fourth displacement from the second predetermined number of predetermined second angle ranges.

After step 690, one-dimensional positions mapped to the selected first and second angle ranges, respectively, are searched in step 692. For clarity, it is assumed that the one-dimensional position mapped to the first angle range is a position in a horizontal direction within the pointing screen 42, and the one-dimensional position mapped to the second angle range is a position in a vertical direction within the pointing screen 42. For performing step 692, the first position mapper 672 searches a one-dimensional position mapped to the first angle range in the horizontal direction as in step 652, and the second position mapper 712 searches a one-dimensional position mapped to the second angle range, which is input from the second angle range determiner 710, in the vertical direction. The first and second position mappers 672 and 712 output the searched horizontal and vertical positions to the information recognizer 714. Each of the first and second position mappers 672 and 712 may include a storage unit (not shown) for previously storing horizontal or vertical positions corresponding to the first predetermined number of the first angle ranges or the second predetermined number of the second angle ranges and a reader (not shown) for reading a horizontal or vertical one-dimensional position from the storage unit using the first or second angle range input from the first or second angle range determiner 670 or 710, as an address.

After step 692, in step 694, a two-dimensional position, that is, horizontal and vertical coordinates, is obtained from the two one-dimensional positions, for example, a horizontal position and a vertical position, information mapped to the two-dimensional position is searched, and the searched information is recognized as information pointed to by the user. For this, the information recognizer 714 searches information mapped to horizontal and vertical coordinates indicating a two-dimensional position, which is derived from the horizontal one-dimensional position input from the first position mapper 672 and the vertical one-dimensional position input from the second position mapper 712, recognizes the searched information as information pointed to by the user, and outputs the recognized information through an output terminal OUT5. Here, the information recognizer 714 may include a storage unit (not shown) for previously storing information corresponding to two-dimensional positions, and a reader (not shown) for reading information from the storage unit by using the two-dimensional position, which is obtained from the one-dimensional positions input from the first and second position mappers 672 and 712, as an address.

When the sensing unit 19A includes the second through sixth sensors 482 through 490, in addition to the first sensor 480 for each of the right and left hands, the information selection unit 468 may simultaneously select a plurality of pieces of information.

An information input device and method for recognizing or inputting information desired by a user among many pieces of information displayed within a pointing screen have been described. The following description concerns the information input device and method for determining information, which is pointed to through such an arrangement as described above, as information to be input.

Usually, a user who is accustomed to a mouse clicks pointed to information to determine the pointed to information as input information. When the user clicks, the third knuckle 424 of the finger 422 shown in FIG. 9 moves. Accordingly, in order to determine whether pointed to information is input information that a user wants to input, the information input method and device shown in FIGS. 10 and 11 senses the motion of the third knuckle 424 using the sixth sensor 490. In other words, the information input device shown in FIG. 11 may be provided with the sixth sensor 490 in the sensing unit 19A in order to determine whether selected information is to be input. Here, in order to check whether a user intends to determine the pointed to information as information to be input, that is, in order to check whether the motion of the third knuckle 424 corresponds to a clicking motion, the information selection unit 468 analyzes a fifth displacement calculated by the signal processor 464 and determines whether the pointed to information is input information in response to the result of analysis.

The second through sixth sensors 482, 484, 486, 488, and 490 may selectively be provided according to applications of the information input device and method. In other words, the sixth sensor 490 shown in FIG. 11 may function as each of sensors 30, 32, 34, and 36 shown in FIG. 2, to sense the click motion of the finger 422, and the third and fourth sensors 484 and 486 may function as a sensor 38 for sensing the upward, downward, leftward, and rightward motions of the hand. Here, only the fourth sensor 486 is provided for the sensor 38, and first or second sensor 480 or 482 may be provided instead of the third sensor 484. In this case, the upward or downward motion of the hand is replaced by a bend of a finger, or the upward or downward motion of the finger. The sensing unit 19 may be provided with the fifth sensor 488 at one or more of fingers 20, 22, 24, and 26 to sense the leftward or rightward motion of a finger.

In an information pointing method according to the present invention, the sixth sensor 490 may be used for clicking an arrow in the horizontal range display section 110 and/or the vertical range display section 112 or used for clicking the initial position 100. Here, in order to rotate the speed selection key 70 clockwise or counterclockwise, for example, all of the the first through sixth sensors 480, 482, 484, 486, 488, and 490 may be used. In this case, the pointer 44 is positioned at the speed selection key 70 by moving a relevant sensor in at least one direction selected from upward, downward, leftward, and rightward. Then, the pointer 44 is clicked by moving the sixth sensor 490. Thereafter, the indicator 130 of the speed selection key 70 is positioned at a desired scale in the range of 1.0-10.0 by using at least one of the first through fifth sensors 480, 482, 484, 486, and 488. The reaction selection key 74 can be operated in a similar way.

Each of steps 14 and 16 of FIG. 1 can be performed by moving the first, second, third, fourth, or fifth sensor 480, 482, 484, 486, or 488. For example, the pointer 44 or the pointing screen 42 can be moved up, down, to the left, or to the right by moving the fourth or fifth sensor 486 or 488.

As described above, a method for pointing information in a multi-dimensional space according to the present invention allows pointing to be precisely performed according to the motion of a user's hand in a three-dimensional space just as when the user uses a mouse in a two-dimensional space. According to the present invention, a screen including a plurality of pieces of information can be reduced to a size set by a user, so the user can easily and conveniently move a pointer to the position of desired information. Particularly, even if a cheap sensor having poor sensitivity is used, a motion in the third-dimensional space can be precisely transmitted according to the present invention.

What is claimed is:

1. A method for pointing at information in a multi-dimensional space, comprising the steps of:
(a) setting a portion of a full screen as a pointing screen;
(b) determining whether desired information to be pointed at is included in the set pointing screen;
(c) when it is determined that the desired information is not included in the pointing screen, moving the pointing screen so that the desired information is included in the pointing screen; and
(d) pointing at the desired information included in the pointing screen when it is determined that the desired information is included in the pointing screen or after step (c),
wherein at least one of steps (a), (c), and (d) is performed by a user's s motion in at least one direction selected from up, down, forward, backward, to the left, and to the right.

2. The method of claim 1, wherein the full screen includes a plurality of pieces of information.

3. The method of claim 1, wherein step (c) comprises the sub-steps of:
(c11) determining whether the desired information is located on the left or right of the pointing screen, when it is determined that the desired information is not included in the pointing screen;
(c12) moving the pointing screen to the left so that the desired information is included in the pointing screen, when it is determined that the desired information is located on the left of the pointing screen, and proceeding to step (d); and
(c13) moving the pointing screen to the right so that the desired information is included in the pointing screen, when it is determined that the desired information is located on the right of the pointing screen, and proceeding to step (d).

4. The method of claim 1, wherein step (c) comprises the sub-steps of:
(c21) determining whether the desired information is located above or below the pointing screen, when it is determined that the desired information is not included in the pointing screen;
(c12) moving the pointing screen up so that the desired information is included in the pointing screen, when it is determined that the desired information is located above the pointing screen, and proceeding to step (d); and
(c13) moving the pointing screen down so that the desired information is included in the pointing screen, when it is determined that the desired information is located below the pointing screen, and proceeding to step (d).

5. The method of claim 1, wherein step (c) comprises the sub-steps of:
(c31) determining whether the desired information is located on the left or right of the pointing screen, when it is determined that the desired information is not included in the pointing screen;
(c32) moving the pointing screen to the left so that the pointing screen is located at a same horizontal position as the desired information, when it is determined that the desired information is located on the left of the pointing screen;
(c33) moving the pointing screen to the right so that the pointing screen is located at a same horizontal position as the desired information, when it is determined that the desired information is located on the right of the pointing screen;
(c34) determining whether the desired information is included in the pointing screen moved in step (c32) or (c33) and proceeding to step (d) when it is determined that the desired information is included in the moved pointing screen;
(c35) determining whether the desired information is located above or below the moved pointing screen, when it is determined that the desired information is not included in the moved pointing screen;
(c36) moving the pointing screen up so that the desired information is included in the pointing screen, when it is determined that the desired information is located above the moved pointing screen, and proceeding to step (d); and
(c37) moving the pointing screen down so that the desired information is included in the pointing screen, when it is determined that the desired information is located below the moved pointing screen, and proceeding to step (d).

6. The method of claim 1, wherein step (c) comprises the sub-steps of:
(c41) determining whether the desired information is located above or below the pointing screen, when it is determined that the desired information is not included in the pointing screen;
(c42) moving the pointing screen up so that the pointing screen is located at a same vertical position as the desired information, when it is determined that the desired information is located above the pointing screen;
(c43) moving the pointing screen down so that the pointing screen is located at a same vertical position as the desired information, when it is determined that the desired information is located below the pointing screen;
(c44) determining whether the desired information is included in the pointing screen moved in step (c42) or (c43) and proceeding to step (d) when it is determined that the desired information is included in the moved pointing screen;
(c45) determining whether the desired information is located on the left or right of the moved pointing screen, when it is determined that the desired information is not included in the moved pointing screen;
(c46) moving the pointing screen to the left so that the desired information is included in the pointing screen, when it is determined that the desired information is located on the left of the moved pointing screen, and proceeding to step (d); and
(c47) moving the pointing screen to the right so that the desired information is included in the pointing screen, when it is determined that the desired information is located on the right of the moved pointing screen, and proceeding to step (d).

7. The method of claim 1, wherein the user's motion is sensed by a sensor.

8. The method of claim 7, wherein the pointing screen is moved by moving the sensor beyond at least one of a horizontal motion range and a vertical motion range, when it is determined that the desired information is not included in the pointing screen in step (c), said at least one of the horizontal motion range and the vertical motion range corresponding to at least one range in which the sensor can be moved to the left/right and upward/downward, respectively, to point at the desired information in step (d).

9. The method of claim 1, wherein in step (a), at least one of a horizontal size and a vertical size of the pointing screen is set.

10. The method of claim 1, wherein in step (a), an initial position which is initially pointed at within the pointing screen is set.

11. The method of claim 1, wherein in step (a), a speed at which the pointing screen is moved is set.

12. The method of claim 1, wherein in step (a), a degree of reaction to the user's motion of a pointer displayed in the pointing screen, is set.

13. The method of claim 1, wherein the full screen corresponds to a graphical-user interface screen.

14. The method of claim 7, wherein the sensor performs a unique pointing function like a mouse.

15. The method of claim 1, wherein in step (d), the desired information pointed at is executed.

16. The method of claim 7, wherein the sensor is included in an information input device.

17. The method of claim 9, wherein the step (a) comprises preparing a size menu used for setting said at least one of the horizontal size and the vertical size.

18. The method of claim 10, wherein the step (a) comprises preparing a size menu used for setting the initial position.

19. The method of claim 11, wherein the step (a) comprises preparing a speed menu used for setting the speed at which the pointing screen is moved.

20. The method of claim 11, wherein the step (a) comprises preparing a reaction menu used for setting the degree of reaction of the pointer.

21. A method for pointing at information in a multi-dimensional space and performing functions of a mouse, the method comprising:
an information selection step of creating a pointing screen at a portion of a full screen at a user's option such that the pointing screen includes at least one piece of information to be executed; and
an information execution step of executing the information included in the pointing screen by clicking the information.
